(19) United States
(12) Patent Application Publication
(10) Pub. No.: US 2007/0234047 A1
(43) Pub. Date: Oct. 4, 2007

(54) Encryption communications using digital certificates with increased security

(75) Inventor: Masafumi Miyazawa, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/723,583

(22) Filed: Mar. 21, 2007

(30) Foreign Application Priority Data
Mar. 30, 2006 (JP) 2006-093914

(51) Int. Cl. H04L 9/00

(52) U.S. Cl. 713/158

(57) ABSTRACT

An apparatus for use in implementing encrypted communications using a digital certificate is disclosed. The apparatus is configured to include a memory storing therein the digital certificate; and a selective-transmit controller, upon receipt of a request from a requester for the encrypted communications using the digital certificate, determining whether or not the digital certificate is valid, transmitting the digital certificate to the requestor if the digital certificate is valid, and not transmitting the digital certificate to the requester if the digital certificate is not valid.

### CROSS-REFERENCE TO RELATED APPLICATIONS

This application is based on Japanese Patent Application No. 2006-093914 filed Mar. 30, 2006, the content of which is incorporated hereinto by reference.

### BACKGROUND OF THE INVENTION

1. Field of the Invention

The invention relates to techniques of implementing encryption or secure communications using digital certificates.

2. Description of the Related Art

A variety of communication techniques are known for implementing communications between communication units over a network (e.g., the Internet, a LAN, a WAN, etc.).

One of those techniques is known as an SSL (Secure Socket Layer) communication protocol which allows the identity of an individual or entity to be verified using digital certificates, and which allows encrypted or secure communications to be authorized and established if the digital certificates were verified to be valid.

Conventional techniques used in digital certificates and encrypted communications are disclosed in, for example, U.S. Pat. No. 6,970,862, the content of which is incorporated hereinto by reference in its entirety.

Current digital certificates are limited in valid lifetime in view of the fact that, although the conventional encrypted communication techniques make it impossible or abundantly extend an amount of time incurred for someone else to decrypt an encrypted message (i.e., a cipher text), the longer the period during which the same key (i.e., a secret key in Public Key Infrastructure (PKI)) has been used, the higher the risk of decryption by someone else.

Digital certificates are each tentatively given a validity period longer than a maximum period within someone else is expectedly able to decrypt an encrypted message without undue effort.

A conventional client device (e.g., a client computer) attempting to establish an encrypted communication, first, receives digital certificates (i.e., server certificates) from a communication apparatus (i.e., a server device) which owns the server certificates.

The conventional client device, upon receipt of server certificates, checks whether or not the received server certificates were issued by a certification authority which is trusted by a user of the client device, and concurrently checks whether or not the certificates are currently valid (such as whether or not the certificates have not been expired, and whether or not the certificates have not been revoked (i.e., canceled or suspended)).

More specifically, the conventional client device activates a particular application program for handling server certificates for verification of the currently-received server certificates. If one or more of the server certificates are owned by a server with which the client device wishes to communicate using an SSL protocol, and if the one or more server certificates have been expired, then the conventional client device displays a warning dialog box to the user for soliciting the user to make a selection as to whether to use the server certificates in question.

The above-described convention techniques are disclosed in, for example, Masakazu Asano “Elementary Course on PKI, Fifth Subject: Validity of Certificates,” at http://www.atmarkit.co.jp/fsecurity/rensai/pki05/pki01.html (last visited Mar. 6, 2006).

It would be desirable to prevent encrypted communications from being performed with degraded or compromised security.

### BRIEF SUMMARY OF THE INVENTION

In general, the invention relates to techniques of implementing encryption or secure communications using digital certificates.

According to some aspects of the invention, a request is received at a communications apparatus (e.g., a server computer) from a requester (e.g., a client computer) for encrypted communication using a digital certificate. Upon receipt of the request, a determination is made, by the communication apparatus, as to whether or not the digital certificate is valid. If the digital certificate is valid, the digital certificate is transmitted, by the communication apparatus, to the requestor, or otherwise the digital certificate is not transmitted, by the communication apparatus, to the requester.

Throughout this description, the terms “a” (or “an”), “one or more,” and “at least one” can be used interchangeably. It is also noted that the terms “comprising,” “including,” and “having” can be used interchangeably.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a view illustrating the configuration of a communications system in accordance with an illustrative embodiment of the present invention;

FIG. 2 is a view illustrating the content of a digital certificate for use in the communications system depicted in FIG. 1;

FIG. 3 is a flow chart illustrating multi-function peripheral processing to be executed by each multi-function peripheral depicted in FIG. 1; and

FIG. 4 is a flow chart illustrating encrypted communication processing included in the multi-function peripheral processing depicted in FIG. 3.

### DETAILED DESCRIPTION OF THE INVENTION

General Overview

According to a first aspect of the invention, there is provided an apparatus for use in implementing encrypted communications using a digital certificate.

The apparatus is arranged to make a determination, upon receipt of a request from a requester for the encrypted communications using a digital certificate at least temporarily stored in the apparatus, as to whether or not the digital certificate is valid.

This apparatus is further arranged to transmit the digital certificate to the requestor if the digital certificate is valid, and not to transmit the digital certificate to the requester if the digital certificate is not valid.

According to a second aspect of the invention, there is provided a method of for use in implementing encrypted communications using a digital certificate.

In this method, a request is received from a requester for the encrypted communications using a digital certificate, and the digital certificate is transmitted to the requestor if the digital certificate is valid, while the digital certificate is not transmitted to the requestor if the digital certificate is not valid.

### ILLUSTRATIVE EMBODIMENTS

According to the invention, the following modes are provided as the illustrative embodiments of the invention.

According to a first mode of the invention, there is provided an apparatus for use in implementing encrypted communications using a digital certificate, comprising:

a memory storing therein the digital certificate; and

a selective-transmit controller, upon receipt of a request from a requester for the encrypted communications using the digital certificate, determining whether or not the digital certificate is valid, transmitting the digital certificate to the requestor if the digital certificate is valid, and not transmitting the digital certificate to the requestor if the digital certificate is not valid.

Conventionally, a user of the aforementioned client device can and might make a selection from the aforementioned warning dialog box displayed to the user, of an instruction to authorize the use of an expired server-certificate. If the user does so, then an encrypted communication is established by performing the processing similar with the processing to be performed if an unexpired server-certificate (i.e., a valid server-certificate) were verified, despite that the current server certificate is not valid.

For example, the possibility exists that a user who has no knowledge of SSL communication techniques makes a selection of an instruction to authorize the use of an expired server-certificate, due to lack of knowledge that the use of an expired server-certificate would lead to establishment of encrypted communications with degraded security, or due to the user's failure to read a warning message in the warning dialog box.

If the user authorizes the use of an expired server-certificate, then encrypted communication is established with degraded security, despite that the warning dialog box was displayed to the user.

There is a typical environment in which a plurality of client devices are arranged to execute respective application programs for establishing encrypted communications when needed.

In this environment, there is diversity in content between the application programs used by the individual client devices. The diversity exists as to whether each application program, upon activation, displays, if digital certificates in question have been expired, a warning dialog box to the user for soliciting the user to make a selection of an instruction to authorize continuation of encrypted communication using the expired digital certificates, or an instruction to inhibit or discontinue encrypted communication using the expired digital certificates.

For this reason, an administrator (e.g., a server device) for the client devices is incapable of providing good control of all the client devices for inhibiting establishment of encrypted communications with degraded security.

In addition, the possibility of establishing encrypted communications with degraded security can arise also when each client device receives a revoked (canceled or suspended) digital certificate.

In contrast, the apparatus according to the first mode of the invention is configured to inhibit a digital certificate used by the apparatus from being sent to the requestor (e.g., a client device) which makes a request for encrypted communication using the digital certificate, if the digital certificate in question is not valid. This apparatus can inhibit an invalid digital certificate from being sent to the requester, without requiring a requester's intervention.

The configuration of this apparatus achieves increased certainty with which encrypted communications are prevented from being implemented with degraded or compromised security.

Notably, this apparatus would allow an administrator (e.g., who manages this apparatus) for the requestor (e.g., a client device) to prevent encrypted communications from being implemented with degraded or compromised security, with increased certainty, also when a user of the requestor (e.g., a client device) uses an application program allowing a warning dialog box to be displayed if a digital certificate in question is not valid.

In an example, the apparatus according to the first mode includes a server computer. The server computer is communicatable over a network with a client computer. The client computer is the requestor, which transmits a request for encrypted communication to the server computer. The server computer is configured not to transmit the digital certificate to the client computer, despite of issuance of the request for encrypted communication from the requestor, if the selective-transmit controller determined that the digital certificate was not valid.

According to a second mode of the invention, the selective-transmit controller in the first mode of the invention includes:

a receiver receiving from the requestor the request for the encrypted communications;

a transmitter transmitting the digital certificate to the requestor;

a determining unit determining whether or not the digital certificate is valid; and

a transmit inhibitor inhibiting the transmitter from transmitting the digital certificate to the requester, if the determining unit determined that the digital certificate was not valid.

According to a third mode of the invention, the selective-transmit controller in the first or second mode of the invention is configured, if the digital certificate was determined not to be valid, not to transmit the digital certificate to the requester, and to inhibit encrypted communications between the requester and a destination from being implemented.

According to a fourth mode of the invention, the memory in any one of the first through third modes of the invention has stored therein a plurality of digital certificates in association with the requestor. Further, the selective-transmit controller in any one of the first through third modes of the invention controller is configured, if determined that at least one of the plurality of digital certificates was valid, to transmit at least one of the at least one valid digital certificate to the requester.

This apparatus is configured to store therein a plurality of digital certificates. This apparatus, as a result, allows encrypted communications between the requester and a destination, if only the digital certificates include a valid one, even if the digital certificates include an invalid one. This apparatus, therefore, provides increased conveniences for users of the client devices.

According to a fifth mode of the invention, the selective-transmit controller in the fourth mode of the invention is configured, if determined that at least one of the plurality of digital certificates was valid, to transmit at least one of the at least one valid digital certificate to the requester, and to permit encrypted communications between the requestor and a destination.

According to a sixth mode of the invention, the apparatus according to any one of the first through fifth modes of the invention is configured to be communicable with a responder managing a certificate revocation list. In this mode, the selective-transmit controller determines, through communications with the responder, whether or not the digital certificate is on the certificate revocation list, and determines that the digital certificate is not valid, if the digital certificate is on the certificate revocation list.

According to a seventh mode of the invention, the memory in the sixth mode of the invention has stored therein a plurality of digital certificates in association with the requestor. Further, the selective-transmit controller in the sixth mode of the invention is configured to transmit to the responder at a time all sets of information required to determine the validity of every one of the plurality of digital certificates by reference to the certificate revocation list.

According to an eighth mode of the invention, there is provided a method of for use in implementing encrypted communications using a digital certificate. This method comprises:

a reception step of receiving a request from a requester for the encrypted communications using the digital certificate;

a determination step of determining, upon receipt of the request, whether or not the digital certificate is valid; and

a selective-transmit step of transmitting the digital certificate to the requestor if the digital certificate is valid, and not transmitting the digital certificate to the requestor if the digital certificate is not valid.

According to a ninth mode of the invention, the selective-transmit step in the eighth mode of the invention includes:

a permit sub-step of permitting a transmission of the digital certificate to the requester, if the digital certificate was determined to be valid; and

an inhibit sub-step of inhibiting a transmission of the digital certificate to the requestor, if the digital certificate was determined not to be valid.

In this method, a digital certificate is inhibited from being sent to a requestor (e.g., a client device) which makes a request for encrypted communication using the digital certificate, if the digital certificate in question is not valid. An invalid digital certificate can be inhibited from being sent to the requester, without requiring a requester's intervention.

According to a tenth mode of the invention, there is provided a computer-readable medium having stored therein a program which, when executed by a computer, implements encrypted communications using a digital certificate.

The program comprises:

instructions for receiving a request from a requester for the encrypted communications using the digital certificate;

instructions for determining, upon receipt of the request, whether or not the digital certificate is valid; and

instructions for transmitting the digital certificate to the requestor if the digital certificate is valid, and not transmitting the digital certificate to the requestor if the digital certificate is not valid.

The term “program” may be interpreted as, for example, a combination of a set of instructions implemented by a computer to perform the function(s) of the program, and associated files, data or the like to be processed according to the instructions.

Additionally, the term “program” may be interpreted as, for example, a structure which achieves the intended purpose(s) by being solely executed by a computer, or a structure which achieves the intended purpose(s) by being executed by a computer together with another program or other programs. In the latter case, the term “program” may be construed mainly as a data structure, for example.

In addition, the “computer-readable medium” may be realized in any one of a variety of types including a magnetic recording medium, such as a flexible-disc, an optical recording medium, such as a CD and a CD-ROM, an optical-magnetic recording medium, such as an MO, an un-removable storage, such as a ROM, for example.

Several presently preferred embodiments of the invention will be described in more detail by reference to the drawings in which like numerals are used to indicate like elements throughout.

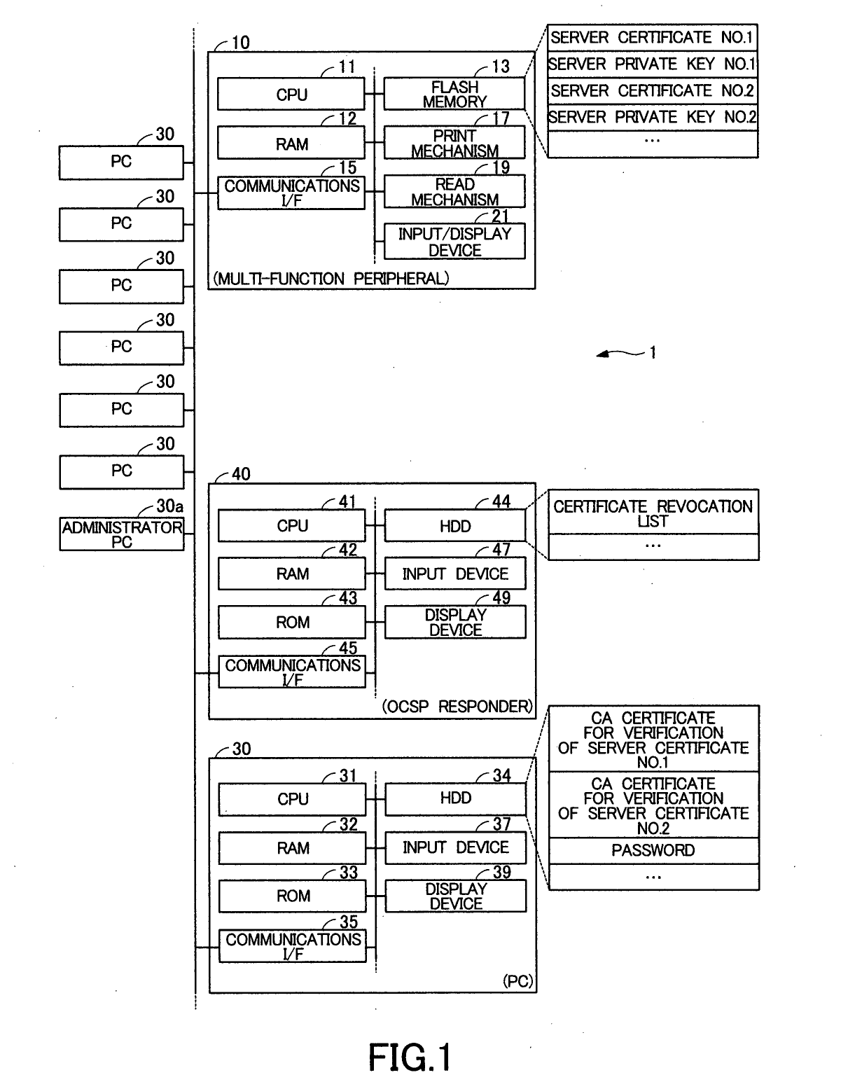

Referring first to FIG. 1, there is illustrated the configuration a communications system 1 constructed in accordance with an illustrative embodiment of the present invention.

As illustrated in FIG. 1, the communications system 1 in the present embodiment is configured such that a plurality of digital multi-function peripherals (hereinafter, referred to simply as “multi-function peripherals”) 10, a plurality of personal computers (hereinafter, referred to simply as “PCs”) 30, and an OCSP (Online Certificate Status Protocol) responder 40 are connected to a TCP/IP (Transmission Control Protocol/Internet Protocol) network.

Notably, the network in the present embodiment is configured to allow the plurality of PCs 30 having similar constructions to be connected to the network.

It is added that each multi-function peripheral 10 constitutes an example of the aforementioned “apparatus for use in implementing encrypted communications.”

Architecture of Multi-Function Peripherals

Each multi-function peripheral 10 is provided with a CPU (Central Processing Unit) 11; a RAM (Random Access Memory) 12 as a work memory; a flash memory 13 storing therein various programs and various sets of data; and a communications interface (“communications I/F” in FIG. 1) 15 connected to the TCP/IP network.

Each multi-function peripheral 10 is further provided with a print mechanism 17 arranged to form an image on a print sheet in a laser manner or an inkjet manner; a read mechanism 19 arranged to optically read a document supported on a document supporting table (not shown), to thereby produce image data; and an input/display device 21 as a user interface which incorporates various user-operable keys (not shown) and a display device (now shown).

The thus-configured multi-function peripherals 10 are each adapted to cause the CPU 11 to execute various programs, to thereby perform various functions including a printing function, a scanning function, a copying function, etc.

More specifically, the CPU 11, in operation, upon receipt of print data from any one of the PCs 30 (i.e., external devices) through the communications interface 15, controls the print mechanism 17 for forming on a print sheet a print image based on the received print data. This refers to the printing function.

The CPU 11, on the other hand, upon receipt of a read command from the input/display device 21 in response to a user action thereto, controls the read mechanism 19 for producing image data indicative of a read image of a document supported on the document supporting table, and transmits the produced image data to a designated one of the PCs 30 through the communications interface 15. This refers to the scanning function.

Additionally, each multi-function peripheral 10 is constructed to further perform the function of a web server and the function of an SSL (Secure Socket Layer) communication; and further include storage areas in the flash memory 13, which are for storage of a plurality of server certificates (i.e., digital certificates) Nos. 1 and 2 which have been issued by a certificate authority (CA, not shown), and for storage of server private keys corresponding to public keys of the respective server certificates.

Still additionally, each multi-function peripheral 10 is constructed to be verify the identity of a client (an associated one of the PCs 30) using a corresponding server certificate, prior to and for authorization of an access from the associated PC 30 to a specific port.

Contents of Digital Certificates

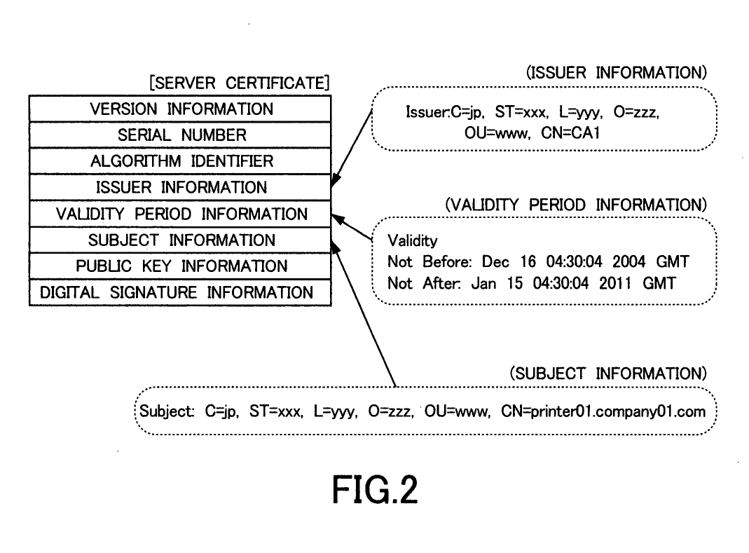

Referring now to FIG. 2, there is illustrated the content of a server certificate which each multi-function peripheral 10 is to store in the flash memory 13.

As illustrated in FIG. 2, a server certificate which is handled by the communications system 1 according to the present embodiment for an SSL communication includes:

Version Information indicating the version of the server certificate;

Serial Number of the server certificate;

Algorithm Identifier;

Issuer Information indicating the signer or issuer of the server certificate who digitally signed;

Validity Period Information indicating the validity period of the server certificate;

Subject Information indicating the subject or owner of the server certificate;

Public Key Information indicating an owner's public key; and

Digital Signature Information indicating a digital signature value.

The subject information of a server certificate has an FQDN (Full Qualified Domain Name) of the corresponding multi-function peripheral 10, while the validity period information of a server certificate is defined to indicate a beginning and an end (i.e., an expiration date) of the validity period of the server certificate.

The serial number of a server certificate, which is used for defining revocation information, is listed in a certificate revocation list (CRL) when the server certificate has been revoked, that is to say, when the server certificate has been cancelled or suspended because a private key corresponding to the server certificate was lost or stolen, because the server certificate was changed in content, or else. The certificate revocation list is maintained by a certificate authority.

Once a recipient of an issued server-certificate (e.g., who maintains the corresponding multi-function peripheral 10) has reported to the certificate authority (i.e., an issuer of the server certificate), the date that the server certificate was revoked (i.e., revocation data) and the revocation reason, together with a certificate serial number, the serial number of the server certificate becomes listed in the certificate revocation list.

The certificate authority updates the certificate revocation list each time the certificate authority is informed, and periodically transmits a newest version of the certificate revocation list to the OCSP responder 40.

The server certificate, once included in the corresponding multi-function peripheral 10, is delivered therefrom to a destination one of the PCs 30 during an SSL communication.

Architecture of Personal Computer

Each PC 30 in the present embodiment is configured so similarly with those of well-known personal computers, as to execute various programs by a CPU 31, to thereby achieve an SSL communication or the like.

More specifically, as illustrated in FIG. 1, each PC 30 is provided with the CPU 31; a RAM 32 as a work memory; a ROM (Read Only Memory) 33 storing therein a boot program, etc.; a Hard Disc Drive (HDD) 34; a communications interface (“communications I/F” in FIG. 1) 35 connected to the TCP/IP network; an input device 37, such as a key board and/or a pointing device; and a display device 39, such as a liquid-crystal monitor screen.

Each PC 30 (which acts as a client computer) has stored in the HDD 34 a CA (Certificate Authority) certificate for verification of the aforementioned server certificate No. 1; a CA certificate for verification of the aforementioned server certificate No. 2; and a password to be presented to the corresponding multi-function peripheral 10 for client authentication.

During an SSL communication, each PC 30, upon receipt of a particular server certificate from the corresponding multi-function peripheral 10, verifies the particular server certificate using the CA certificates which have been stored in the HDD 34.

Upon start of a Secure Socket Layer (SSL) handshake, each PC 30 transmits the password stored in the HDD 34 to the corresponding multi-function peripheral 10 for its client authentication.

Architecture of Online Certificate Status Protocol Responder

The OCSP responder 40, which is in the form of a well-known server in which an OCSP (Online Certificate Status Protocol) is implemented, is configured to include a CPU 41; a RAM 42; a ROM 43; a Hard Disc Drive (HDD) 44; a communications interface (“communications I/F” in FIG. 1) 45; an input device 47; and a display device 49, similarly with the PCs 30.

The HDD 44 in the OCSP responder 40 stores therein a certificate revocation list, upon periodical receipt from certificate authorities. The certificate revocation list is a “list of certificates which became invalid prior to the indicated expiration dates,” and contains sets of a certificate serial number for identifying a revoked server certificate, the revocation date and the revocation reason, all of which are included in the certificate revocation list in linked relation with one another.

In operation, the OCSR responder 40 periodically receives the newest version of a certificate revocation list from the certificate authority, and in turn, overwrites the existing version of the certificate revocation list with the newly-received version of the certificate revocation list, to thereby allow only the newest version of the certificate revocation list to be stored in the HDD 44.

Upon receipt of an OCSP request together with a certificate serial number, from the corresponding multi-function peripheral 10, the OCSP responder 40 determines whether or not the certificate-serial-number in question is on the certificate revocation list.

If the certificate-serial-number in question is on the certificate revocation list, then the OCSP responder 40 responds to the requester of the OCSP request that the certificate in question is invalid or in a “non-OK” status, or otherwise the OCSP responder 40 responds that the certificate in question is valid or in an “OK” status.

Algorithm of Communications by Multi-Function Peripherals

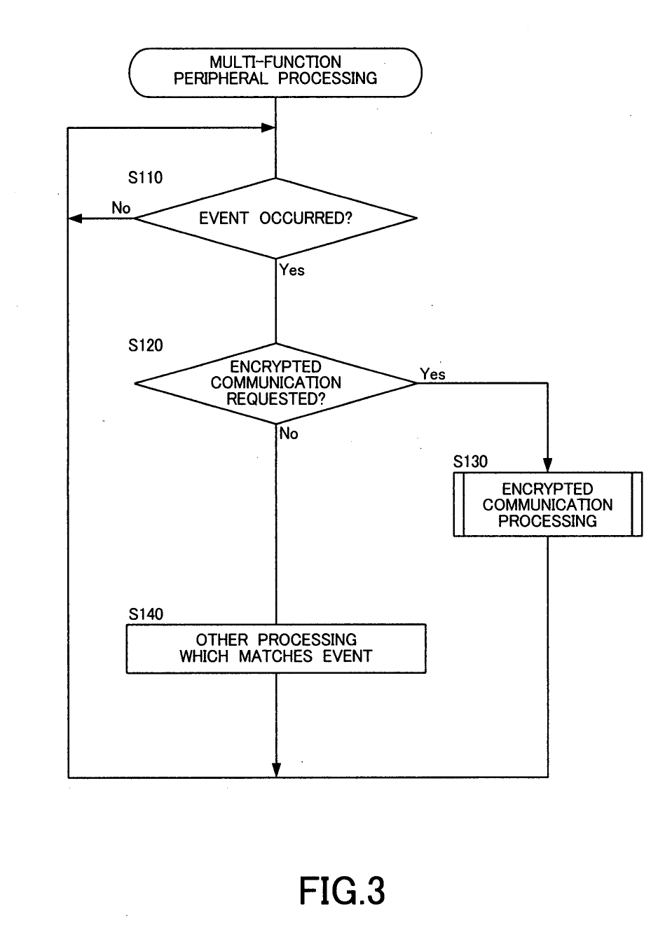

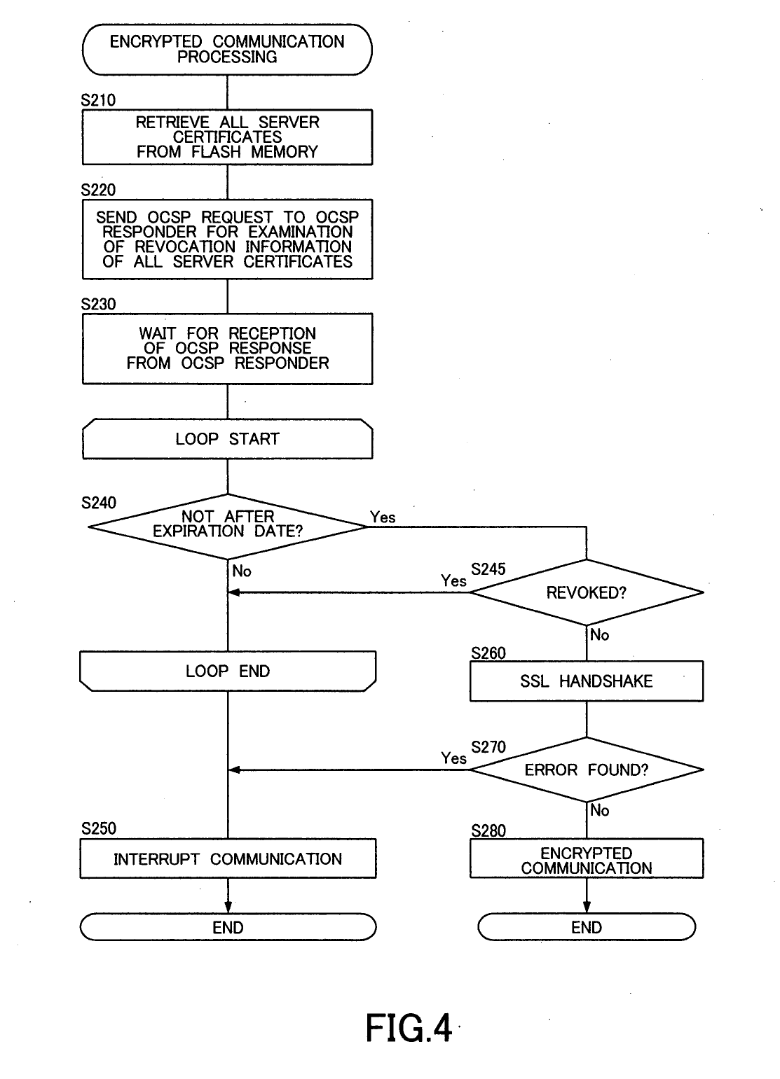

Referring next to FIGS. 3 and 4, there will be described below the communications processing performed in each multi-function peripheral 10.

FIG. 3 is a flow chart illustrating multi-function-peripheral processing to be performed by the CPU 11 in each multi-function peripheral 10, and FIG. 4 is a flow chart illustrating encrypted communication processing included in the multi-function-peripheral processing.

Each multi-function peripheral 10 performs the multi-function-peripheral processing illustrated in FIG. 3, to thereby receive print data transmitted and authorize access to various Web pages.

The multi-function-peripheral processing is initiated upon activation of each individual multi-function peripheral 10. Upon initiation of the multi-function-peripheral processing, the CPU 11 determines whether or not an event has occurred, such as access to an HTTPS (Hypertext Transfer Protocol Secure) port (i.e., encrypted or secure Web-access), access to an HTTP (Hypertext Transfer Protocol) port (i.e., non-encrypted or non-secure Web-access), access to a port for encrypted-data-printing, access to a port for non-encrypted-data-printing, or receipt of a packet from an administrator PC 30a or another one of the multi-function peripherals 10 (step S110).

If such an event has occurred (“Yes” branch of step S110), then the CPU 11 determines whether or not the event is the receipt of a request for an encrypted communication from other devices, that is to say, access to an HTTPS port or a port for encrypted-data-printing (step S120). If the event is the receipt of a request for an encrypted communication (“Yes” branch of step S120), then the CPU 11 performs the encrypted communication processing illustrated in FIG. 4 (step S130), and, upon termination of the encrypted communication processing, returns to step S110 to enter a wait state for an occurrence of a next event.

If, however, at step S120, it is determined that the event is not the receipt of a request for an encrypted communication (“No” branch of step S120), then the CPU 11 performs additional processing corresponding to the event (step S140), and, upon termination of the additional processing, returns to step S110.

Roughly describing, the encrypted communication processing (step S130) is the processing to determine as to whether or not a negotiated server-certificate is valid, based on a determination as to whether or not the server certificate has been expired and a determination as to whether or not the server certificate has been revoked, providing control of the status of an encrypted communication (with an SSL communication).

Each multi-function peripheral 10, upon receipt of a request for an encrypted communication from an associated one of the PCs 30 (step S120 in FIG. 3), initiates the processing illustrated in FIG. 4.

Algorithm of Encrypted Communication

In the processing for an encrypted communication, first, all the server certificates which have been stored in the flash memory 13 are retrieved therefrom (step S210). Next, in order to examine the revocation information of all the server certificates retrieved at step S210, the serial numbers which have been assigned to all the server certificates are sent to the OCSP responder 40, to thereby make an OCSP request (step S220).

Upon receipt of the OCSP request together with certificate serial numbers, the OCSP responder 40 checks whether or not the received serial numbers are included in the certificate revocation list stored in the HDD 44.

If each of the received serial numbers is not included in the certificate revocation list, then the corresponding server certificate, as not revoked, is assigned a valid status or an “OK” status. If, however, each of the received serial numbers is included in the certificate revocation list, then the corresponding server certificate, as revoked, is assigned an invalid status or a “non-OK” status.

Upon completion of the validity checking for all the serial numbers in the above manner, the OSCP responder 40 transmits a response packet containing both certificate serial numbers and the corresponding validity status information (the “OK” or the “non-OK” status), linked to each other.

Upon receipt of the response packet from the OCSP responder 40 (step S230), each multi-function peripheral 10 determines whether or not each server certificate is valid (step S240).

More specifically, the multi-function peripheral 10 first retrieves a currently-selected one of the server certificates from the flash memory 13, and next determines whether or not the present time and date is within the validity period indicated in the current server certificate, that is to say, whether or not the current server certificate has not yet been expired.

If, as a result, it is determined that the current server certificate has been expired (“No” branch of step S240), then the current server certificate is determined not to be valid, and therefore, a determination is made as to whether or not there is a next server certificate left unprocessed. If so, then a determination is made as to whether or not the next server certificate is valid.

If, eventually, it is determined that all the server certificates which have been stored in the flash memory 13 have been expired, then this encrypted communication processing progresses to step S250 to interrupt the requested encrypted communication, resulting in termination of this encrypted communication processing.

If, however, at step S240, it is determined that the current server certificate has not been expired (“Yes” branch of step S240), then a determination is made as to whether or not the current server certificate has been revoked, by determining whether the response packet received at step S230 represents that the same serial number as that indicated in the current server certificate is assigned the “OK” status or the “non-OK” status.

If it is determined that the current server certificate has been revoked (“Yes” branch of step S245), then a determination is made as to whether or not there is a next server certificate left unprocessed. If so, then a determination is made as to whether or not the next server certificate is valid.

If, eventually, it is determined that all the server certificates which have been stored in the flash memory 13 have been expired or revoked, then this encrypted communication processing progresses to step S250 to interrupt the requested encrypted communication, resulting in termination of this encrypted communication processing.

In an alternative embodiment, the decision steps S240 and S245 may be performed successively but in an order reverse to that in FIG. 4.

In a still alternative embodiment, each time that step S245 is implemented for checking the status of a current server certificate, each multi-function peripheral 10 may request the OCSP responder 40 to respond to each multi-function peripheral 10 with only one of pieces of the status information of the certificate revocation list which corresponds to the serial number of the current server certificate.

In the present embodiment described above with reference to the accompanying drawings, each multi-function peripheral 10 is adapted to make a collective OCSP request for all the server certificates which have been stored in the flash memory 13, prior to the initiation of certificate-by-certificate verification, allowing the number of processing steps and the load of traffic to be reduced accordingly.

If, at both steps S240 and S245, it is determined that at least one of the server certificates is valid (that is to say, if the at least one server certificate has not been expired (“Yes” branch of step S240), and if the corresponding response from the OCSP responder 40 indicates that the at least one server certificate is valid (“No” branch of step S245)), then operation progresses to step S260 to transmit a valid server certificate to one of the PCs 30 which is a requester of the requested encrypted communication, to thereby implement an SSL handshake.

If an error occurs during the SSL handshake (“Yes” branch of step S270), then the requested encrypted communication is interrupted (step S250), resulting in termination of this encrypted communication processing.

If, however, no error occurs during the SSL handshake (“No” branch of step S270), then the requested SSL-encrypted communication is implemented in a predetermined fashion (step S280), and this encrypted communication processing is terminated after completion of the requested encrypted communication.

In the present embodiment, a server certificate, if invalid, is blocked from being sent from the associated multi-function peripheral 10 to the associated PC 30. This provides a user who operates the associated PC 30 with the knowledge that a targeted server certificate is no longer valid. The knowledge promotes the user to update the invalid certificate or do something like that, to thereby allow any server certificate to be maintained to be valid, as persistently as possible.

Further, in the present embodiment, on the side of each multi-function peripheral 10 which owns server certificates, these certificates are verified with respect to validity/invalidity, and each certificate, if invalid, is inhibited from being sent from each multi-function peripheral 10 to an associated PC 30, thereby possibly eliminating useless communications between those multi-function peripheral 10 and PC 30.

In the present embodiment, step S250 is implemented to interrupt the requested encrypted communication, while notifying the user on the side of each PC 30 of the reason why the requested encrypted communication is interrupted (an exemplary reason is that the corresponding server certificate is invalid), thereby allowing the user to appreciate the reason why the requested encrypted communication is interrupted, with greater certainty.

As will be apparent from the above explanation, in the present embodiment, the flash memory 13, illustratively, constitutes an example of the “memory” set forth in the above-described first mode of the invention, and a portion of the CPU 11, the RAM 12 and the flash memory 13 (hereinafter, collectively referred to as “computer”) in each multi-function peripheral 10 which is assigned to implement the encrypted communication processing illustrated in FIG. 4, illustratively, constitutes an example of the “selective-transmit controller” set forth in the same mode.

Further, in the present embodiment, a portion of the computer in each multi-function peripheral 10 which is assigned to implement step S120 depicted in FIG. 3, illustratively, constitutes an example of the “receiver” set forth in the above-described second mode of the invention, a portion of the computer which is assigned to implement steps S210-S245, illustratively, constitutes an example of the “determining unit” set forth in the same mode, and a portion of the computer which is assigned to implement step S260 depicted in FIG. 4, illustratively, constitutes an example of the “transmitter” set forth in the same mode.

Although a preferred embodiment of the present invention has been described above, the embodiment is just illustrative and not limiting nor exclusive. The present invention may be practiced in a variety of alternative embodiments, without departing from the spirit and scope of the present invention.

For example, in the present embodiment, encrypted communications are implemented in an SSL communication protocol. However, encrypted communications may be implemented in alternative communication protocols, provided that these protocols can handle digital certificates.

Additionally, in the present embodiment, each multi-function peripheral 10 uses server certificates which are issued by a certificate authority. Alternatively, each multi-function peripheral 10 may be configured to act as if it were a certificate authority, so as to self-sign server certificates and check the validity of the self-signed server certificates.

In this alternative, each multi-function peripheral 10 can maintain a certificate revocation list using the thus-added certificate authentication function, allowing each multi-function peripheral 10 to determine whether or not each server certificate has been revoked, by making an inquiry into the certificate revocation list maintained using the certificate authentication function, without necessity of attaching a separate OCSP responder to the network.

In the present embodiment, encrypted Web-access and access to a port for encrypted-data-printing are employed as exemplary versions of encrypted communication. However, they are not limiting nor exclusive, and different versions of encrypted communication, such as encrypted scan-access, may be employed alternatively or additionally. Even in this instance, the validity of server certificates can be checked on the side of each multi-function peripheral 10, similarly with the present embodiment.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An apparatus for use in implementing encrypted communications using a digital certificate, comprising:
a memory storing therein the digital certificate; and
a selective-transmit controller, upon receipt of a request from a requester for the encrypted communications using the digital certificate, determining whether or not the digital certificate is valid, transmitting the digital certificate to the requestor if the digital certificate is valid, and not transmitting the digital certificate to the requestor if the digital certificate is not valid.

2. The apparatus according to claim 1, wherein the selective-transmit controller includes:
a receiver receiving from the requestor the request for the encrypted communications;
a determining unit determining whether or not the digital certificate is valid; and
a transmitter transmitting the digital certificate to the requestor if the determining unit determined that the digital certificate was valid, and not transmitting the digital certificate to the requestor if the determining unit determined that the digital certificate was not valid.

3. The apparatus according to claim 1, wherein the selective-transmit controller is configured, if the digital certificate was determined not to be valid, not to transmit the digital certificate to the requester, and to inhibit encrypted communications between the requester and a destination from being implemented.

4. The apparatus according to claim 1, wherein the memory has stored therein a plurality of digital certificates in association with the requestor, and
the selective-transmit controller is configured, if determined that at least one of the plurality of digital certificates was valid, to transmit at least one of the at least one valid digital certificate to the requestor.

5. The apparatus according to claim 4, wherein the selective-transmit controller is configured, if determined that at least one of the plurality of digital certificates was valid, to transmit at least one of the at least one valid digital certificate to the requester, and to permit encrypted communications between the requestor and a destination.

6. The apparatus according to claim 1, configured to be communicable with a responder managing a certificate revocation list, wherein the selective-transmit controller determines, through communications with the responder, whether or not the digital certificate is on the certificate revocation list, and determines that the digital certificate is not valid, if the digital certificate is on the certificate revocation list.

7. The apparatus according to claim 6, wherein the memory has stored therein a plurality of digital certificates in association with the requestor, and
the selective-transmit controller is configured to transmit to the responder at a time all sets of information required to determine the validity of every one of the plurality of digital certificates by reference to the certificate revocation list.

8. A method of for use in implementing encrypted communications using a digital certificate, comprising:
a reception step of receiving a request from a requester for the encrypted communications using the digital certificate;
a determination step of determining, upon receipt of the request, whether or not the digital certificate is valid; and
a selective-transmit step of transmitting the digital certificate to the requester if the digital certificate is valid, and not transmitting the digital certificate to the requester if the digital certificate is not valid.

9. The method according to claim 8, wherein the selective-transmit step includes:
a permit sub-step of permitting a transmission of the digital certificate to the requester, if the digital certificate was determined to be valid; and
an inhibit sub-step of inhibiting a transmission of the digital certificate to the requester, if the digital certificate was determined not to be valid.

10. A computer-readable medium having stored therein a program which, when executed by a computer, implements encrypted communications using a digital certificate, the program comprising:
instructions for receiving a request from a requester for the encrypted communications using the digital certificate;
instructions for determining, upon receipt of the request, whether or not the digital certificate is valid; and
instructions for transmitting the digital certificate to the requestor if the digital certificate is valid, and not transmitting the digital certificate to the requestor if the digital certificate is not valid.
